(19) United States
(12) Patent Application Publication
(10) Pub. No.: US 2010/0031001 A1
(43) Pub. Date: Feb. 4, 2010

(54) SERIAL MEMORY DEVICE AND SIGNAL PROCESSING SYSTEM

(76) Inventors: Masahiro Ueminami, Kyoto (JP); Kazuyo Nishikawa, Osaka (JP); Masahiro Kuramochi, Hyogo (JP); Tadashi Nitta, Kyoto (JP); Toshiki Mori, Osaka (JP)

Correspondence Address: MCDERMOTT WILL & EMERY LLP, 600 13TH STREET, NW, WASHINGTON, DC, 20005-3096, US

(21) Appl. No.: 12/487,170

(22) Filed: Jun. 18, 2009

(30) Foreign Application Priority Data
Jul. 31, 2008 (JP) 2008-197894

(51) Int. Cl. G06F 12/06

(52) U.S. Cl. 711/217; 711/E12.084

(57) ABSTRACT

In a serial memory device which performs reception and transmission of command, address, and data via serial communication with a host controller, a base address holding circuit holds a base address which serves as a base for effective address calculation. An address operation circuit calculates an effective address based on the base address and an address input from the host controller.

### CROSS-REFERENCE TO RELATED APPLICATIONS

This application claims priority from Japanese Patent Application No. 2008-197894 filed on Jul. 31, 2008, which is hereby incorporated by reference in its entirety for all purposes.

### BACKGROUND

A technology disclosed in this specification relates to a semiconductor memory device and specifically to a serial memory device which performs reception and transmission of commands, addresses, and data via serial communication with a host controller and a signal processing system which includes the serial memory device.

For high density packaging of a signal processing system, reduction in the number of signal lines which connect a memory device and a host controller is effective. Examples of memory devices which meet the demand for high density packaging include serial memory devices. The I/O of a typical serial memory device is composed of a single input pin and a single output pin. Thus, such a serial memory device can be realized in the form of a compact package with a small number of pins.

The serial memory device can operate on a system clock signal of, for example, 100 MHz to read data at 80 ns/byte (12.5 Mbyte/s). In other words, the serial memory device achieves a data read rate equal to that of a parallel memory device which has a parallel data terminal of 8 bits or 16 bits. A type of serial memory device achieves a high data read rate by activating a row decoder at the timing when a row address is input, before input of all the bits of an address is completed (see, for example, WO99/59154).

### SUMMARY

The data read rate of the serial memory device is relatively high in burst transfer but relatively low in random access. This is because the random access requires input of a command and address for every reading of unit data, resulting in a large overhead.

In a signal processing system which reads and executes a process code stored in a memory device, a random access to the memory device occurs when a branch instruction, such as a jump instruction, occurs. When data are also stored in the memory device, reading of data frequently alternates between a code region and a data region, and random access frequently occurs. Therefore, there is a probability that using a serial memory device in a signal processing system decreases the processing rate.

In view of the above circumstances, the serial memory device examples which will be described below may advantageously provide an increased random access rate.

An example serial memory device which may provide such an advantage is a serial memory device which performs reception and transmission of command, address, and data via serial communication with a host controller, the serial memory device including: a base address holding circuit for holding a base address which serves as a base for effective address calculation; and an address operation circuit for calculating an effective address based on the base address and an address input from the host controller. In this serial memory device, the effective address can be calculated only by inputting from the host controller an address difference from the base address. Therefore, the time required for address input is reduced. Accordingly, the overhead during random access is reduced so that the random access rate can be increased.

Specifically, the address operation circuit may include an adder for adding together the base address and the address input from the host controller. In this structure, the effective address can be calculated from the base address and the address input from the host controller by a simple addition. Preferably, the address input from the host controller may be represented by a two's complement. In this structure, an effective address which falls within a predetermined range from the base address at its center can be accessed at a high rate.

Preferably, the address operation circuit may select as an effective address any one of an address calculated by adding together the base address and the address input from the host controller or the address input from the host controller according to a command input from the host controller. In this structure, the high-rate address input and the conventional address input can be switched by a command.

Preferably, the base address holding circuit may update an address held therein to an address output from the address operation circuit when a predetermined command from the host controller is input to the base address holding circuit. In this structure, the timing of updating the base address can be arbitrarily controlled, and therefore, the high-rate address input can be carried out at the timing desired by the user.

### BRIEF DESCRIPTION OF THE DRAWINGS

FIG. 1 shows a structure of an example serial memory device and an example signal processing system which includes the example serial memory device.

FIG. 2 shows a structure of an address operation circuit and a base address holding circuit.

FIG. 3 is a timing chart for absolute address access.

FIG. 4 is a timing chart for relative address access.

FIG. 5 is a timing chart for base address update.

FIG. 6 is a timing chart for base address holding.

### DETAILED DESCRIPTION

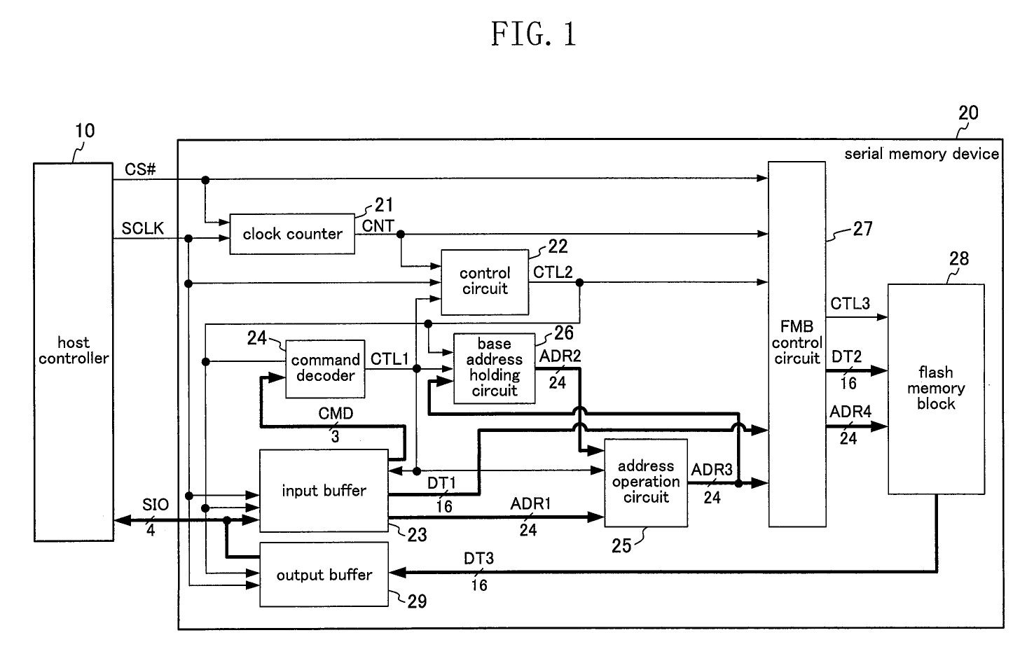

Hereinafter, examples of serial memory device and signal processing system are described with reference to the drawings. FIG. 1 shows a structure of an example serial memory device and an example signal processing system which includes the example serial memory device. A host controller 10 and the serial memory device 20 are connected by 4-bit input/output signal SIO which is to be input to a data terminal SIO, system clock signal SCLK which is to be input to a clock terminal SCLK, and chip select signal CS#. Note that, for convenience of illustration, the memory capacity of the serial memory device 20 is 16 Mbits, and any 1 bit is specified by an address of 24 bits.

In the serial memory device 20, a clock counter 21 counts system clock signal SCLK in synchronization with chip select signal CS# to output count signal CNT. A control circuit 22 receives count signal CNT, system clock signal SCLK, and control signal CTL1, which will be described later, to output control signal CTL2. An input buffer 23 takes in commands, addresses and data serially input by input/output signal SIO in synchronization with system clock signal SCLK according to control signals CTL1 and CTL2 to output 3-bit command signal CMD, 24-bit address signal ADR1, and 16-bit data signal DT1. A command decoder 24 decodes command signal CMD according to control signal CTL2 to output control signal CTL1. An address operation circuit 25 receives address signal ADR1 and address signal ADR2, which will be described later, and calculates the effective address from these address signals according to control signal CTL1 to output 24-bit address signal ADR3. A base address holding circuit 26 holds a base address which serves as a base for effective address calculation. Also, the base address holding circuit 26 receives address signal ADR3 to update the address held therein to address signal ADR3 according to control signals CTL1 and CTL2. A flash memory block control circuit 27 receives count signal CNT, control signal CTL2, data signal DT1 and address signal ADR3 to output control signal CTL3, 16-bit data signal DT2, and 24-bit address signal ADR4. A flash memory block 28 receives control signal CTL3, data signal DT2 and address signal ADR4 and operates on these signals. An output buffer 29 takes in 16-bit data signal DT3 output from the flash memory block 28 according to control signal CTL2 to output input/output signal SIO in synchronization with system clock signal SCLK.

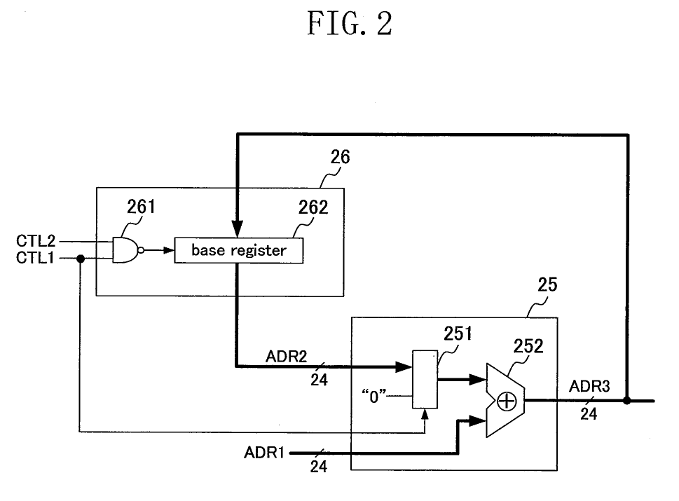

FIG. 2 shows a structure of the address operation circuit 25 and the base address holding circuit 26. In the address operation circuit 25, a selector circuit 251 selects any one of address signal ADR2 and a zero signal according to control signal CTL1. An adder 252 adds together the output of the selector circuit 251 and address signal ADR1 to output address signal ADR3. Thus, the address operation circuit 25 outputs address signal ADR1 itself or outputs a result of addition of address signal ADR1 and address signal ADR2. In the base address holding circuit 26, a NAND gate 261 outputs the NAND of control signals CTL1 and CTL2. A base register 262 receives address signal ADR3. The base register 262 updates the value held therein to address signal ADR3 when the output of the NAND gate 261 transitions to L-level. Thus, the base address is not updated so long as control signal CTL1 is driven to L-level irrespective of the level of control signal CTL2.

The commands input to the thus-structured serial memory device 20 and the operation modes corresponding thereto are shown in the table below.

| SIO[3] | SIO[2] | SIO[1] | SIO[0] | operation | | base address |
|---|---|---|---|---|---|---|
| H | H | H | X | read | relative | hold |
| H | H | L | X | | address | update |
| | | | | | access | |
| H | L | L | X | write | absolute | hold |
| L | H | X | X | read | address | hold |
| L | L | X | X | | access | update |

Absolute Address Access is an operation mode where the flash memory block 28 is accessed with a 24-bit address input from the host controller 10 being used as an effective address. Relative Address Access is an operation mode where the flash memory block 28 is accessed with the sum of the base address held in the base address holding circuit 26 and an 8-bit address input from the host controller 10 being used as an effective address. Base Address Update is an operation mode where the flash memory block 28 is accessed while the address held in the base address holding circuit 26 is updated to an interested effective address. Base Address Hold is an operation mode where the flash memory block 28 is accessed, but the address held in the base address holding circuit 26 is not updated. These operation modes during data reading are described below with reference to the timing charts.

<<Absolute Address Access>>

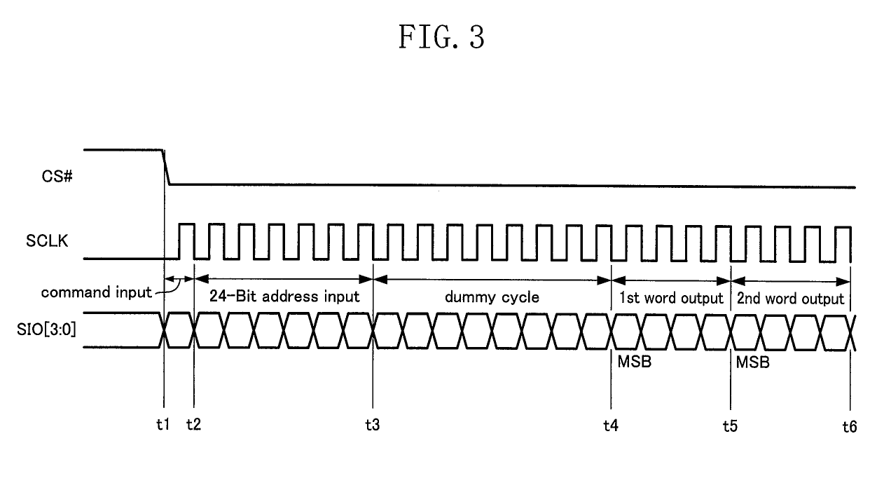

FIG. 3 is a timing chart for absolute address access. At t1, chip select signal CS# is driven to L-level, and then, a 3-bit command which is indicative of absolute address access is input from the host controller 10 as input/output signal SIO for a duration of one cycle of system clock signal SCLK. In the interval from t2 to t3, a 24-bit address is input from the host controller 10 as input/output signal SIO, on a 4-bit by 4-bit basis, for a duration of 6 cycles of system clock signal SCLK.

When the 24-bit address is taken in the input buffer 23, the input buffer 23 outputs address signal ADR1. Meanwhile, the control circuit 22 and the command decoder 24 respectively output control signals CTL2 and CTL1 for absolute address access to the serial memory device 20. Therefore, the selector circuit 251 selects the zero signal according to control signal CTL1, and the adder 252 outputs address signal ADR1 itself as address signal ADR3. Thus, in the serial memory device 20, the flash memory block 28 is accessed with the 24-bit address input from the host controller 10 being used as the absolute address.

After the start of the access to the flash memory block 28 and the elapse of a dummy cycle from t3 to t4 which is necessary for data reading, data signal DT3 is output from the flash memory block 28. Then, in the interval from t4 to t5, the data of the first word is output as input/output signal SIO, on a 4-bit by 4-bit basis with the MSB at the leading end of the first 4 bits, for a duration of 4 cycles of system clock signal SCLK.

The address taken in the input buffer 23 is counted up in synchronization with system clock signal SCLK. The address input from the host controller 10 is sequentially counted up and input to the flash memory block 28. Thus, the data output of the first word is immediately followed by the data output of the second word in the interval from t5 to t6. Thereafter, the data of the third and subsequent words are serially output in the same way.

<<Relative Address Access>>

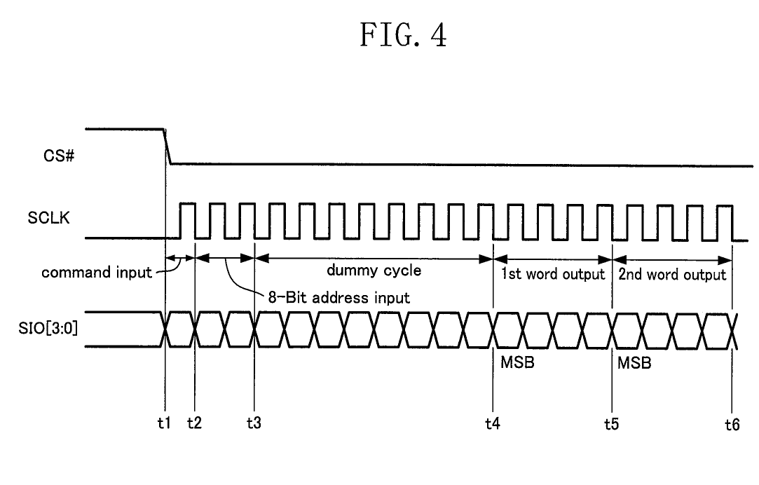

FIG. 4 is a timing chart for relative address access. At t1, chip select signal CS# is driven to L-level, and then, a 3-bit command which is indicative of relative address access is input from the host controller 10 as input/output signal SIO for a duration of one cycle of system clock signal SCLK. In the interval from t2 to t3, an 8-bit address is input from the host controller 10 as input/output signal SIO, on a 4-bit by 4-bit basis, for a duration of 2 cycles of system clock signal SCLK.

When the 8-bit address is taken in the input buffer 23, the input buffer 23 outputs address signal ADR1. Meanwhile, the control circuit 22 and the command decoder 24 respectively output control signals CTL2 and CTL1 for relative address access to the serial memory device 20. Therefore, the selector circuit 251 selects address signal ADR2 according to control signal CTL1, and the adder 252 outputs the result of addition of address signal ADR1 and address signal ADR2 as address signal ADR3. Thus, in the serial memory device 20, the flash memory block 28 is accessed with the 8-bit address input from the host controller 10 being used as the relative address that represents the distance from the base address. The address input from the host controller 10 may be represented by a two's complement. In this case, the effective address can be calculated in the range of +127 to −128 from the base address. Note that part of the operation after t3 is the same as that described above for absolute address access.

As described above, the operation in relative address access can reduce the time required for address input. Thus, using relative address access can increase the random access rate of the serial memory device 20. Especially in the case where the example signal processing system of FIG. 1 reads and executes a process code from the serial memory device 20, describing a jump instruction, or the like, in relative address representation can serve to improve the processing rate of the signal processing system.

<<Base Address Update>>

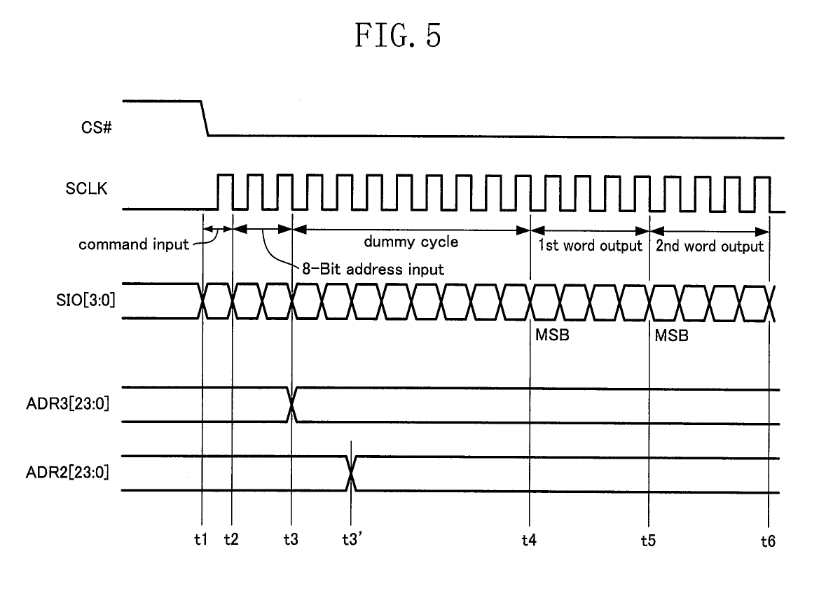

FIG. 5 is a timing chart for base address update. At t1, chip select signal CS# is driven to L-level, and then, a 3-bit command which is indicative of both relative address access and base address update is input from the host controller 10. Note that part of the operation after t1 relevant to the input of commands and addresses and the output of data is the same as that described above for relative address access, and the description thereof is herein omitted.

When the 8-bit address is taken in the input buffer 23, the input buffer 23 outputs address signal ADR1. Accordingly, at t3, the address operation circuit 25 updates address signal ADR3. Meanwhile, the command decoder 24 outputs control signal CTL1 for base address update. At t3′ that occurs after the update of address signal ADR3, the control circuit 22 outputs control signal CTL2 for base address update, and accordingly, the base address holding circuit 26 updates the address held therein to address signal ADR3.

Note that base address update is also applicable in the context of absolute address access.

<<Base Address Hold>>

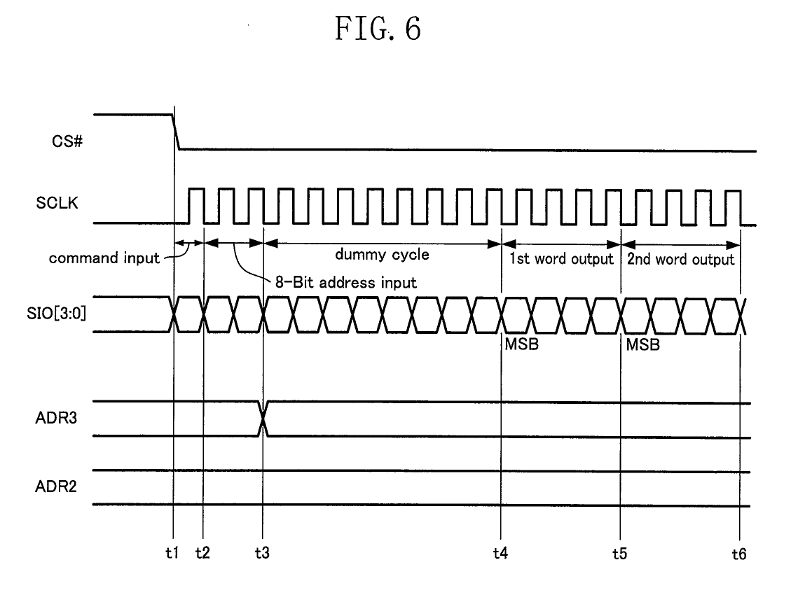

FIG. 6 is a timing chart for base address hold. At t1, chip select signal CS# is driven to L-level, and then, a 3-bit command which is indicative of both relative address access and base address hold is input from the host controller 10. Note that part of the operation after t1 relevant to the input of commands and addresses and the output of data is the same as that described above for relative address access, and the description thereof is herein omitted.

When the 8-bit address is taken in the input buffer 23, the input buffer 23 outputs address signal ADR1. Accordingly, at t3, the address operation circuit 25 updates address signal ADR3. Meanwhile, the command decoder 24 outputs control signal CTL1 for base address hold. Therefore, even when address signal ADR3 is updated, the base address holding circuit 26 does not update the address held therein.

Note that base address hold is also applicable in the context of absolute address access.

Specifically, in the case where the process codes and data of the example signal processing system of FIG. 1 are stored in the serial memory device 20, the base address is updated at the time of reading of a process code whereas the base address is held unchanged at the time of reading of data. Therefore, when data is once read from the data region during the execution of a process code and then a next process code is read again from the process code region, the process code can be read at a high rate in the relative address access mode.

Thus, in the above-described example signal processing system, the random access rate of the serial memory device 20 can be increased, and hence, the processing rate of the signal processing system can be improved. Note that the IO between the host controller 10 and the serial memory device 20 is not limited to 4-bit input/output signal SIO. It may be a combination of a single serial input and a single serial output or may be a 2-bit input/output signal. Also, the serial memory device 20 is not limited to a serial flash memory.

What is claimed is:

1. A serial memory device which performs reception and transmission of command, address, and data via serial communication with a host controller, the serial memory device comprising:
a base address holding circuit for holding a base address which serves as a base for effective address calculation; and
an address operation circuit for calculating an effective address based on the base address and an address input from the host controller.

2. The serial memory device of claim 1, wherein the address operation circuit includes an adder for adding together the base address and the address input from the host controller.

3. The serial memory device of claim 2, wherein the address input from the host controller is represented by a two's complement.

4. The serial memory device of claim 1, wherein the address operation circuit selects as an effective address any one of an address calculated by adding together the base address and the address input from the host controller or the address input from the host controller according to a command input from the host controller.

5. The serial memory device of claim 1, wherein the base address holding circuit updates an address held therein to an address output from the address operation circuit when a predetermined command from the host controller is input to the base address holding circuit.

6. The serial memory device of claim 2, wherein the base address holding circuit updates an address held therein to an address output from the address operation circuit when a predetermined command from the host controller is input to the base address holding circuit.

7. The serial memory device of claim 3, wherein the base address holding circuit updates an address held therein to an address output from the address operation circuit when a predetermined command from the host controller is input to the base address holding circuit.

8. The serial memory device of claim 4, wherein the base address holding circuit updates an address held therein to an address output from the address operation circuit when a predetermined command from the host controller is input to the base address holding circuit.

9. A serial memory device which performs reception and transmission of command, address, and data via serial communication with a host controller, the serial memory device comprising:
a data terminal to which a command and an address are input; and
a clock terminal to which a clock signal is input, wherein
if a first command is input to the data terminal and then a first address is input to the data terminal for a duration of N cycles of the clock signal (N is a natural number), the first address is used as an effective address, and a base address is updated to the first address, and
if a second command is input to the data terminal and then a second address is input to the data terminal for a duration of M cycles of the clock signal (M is a natural number smaller than N), a third address which is an operation result of the base address and the second address is used as an effective address, and the base address is updated to the third address.

10. The serial memory device of claim 9, wherein if a third command is input to the data terminal and then a fourth address is input to the data terminal for a duration of N cycles of the clock signal, the fourth address is used as an effective address while the base address is not updated.

11. The serial memory device of claim 9, wherein the third address is calculated by adding the second address to the base address.

12. The serial memory device of claim 11, wherein the second address is represented by a two's complement.

13. The serial memory device of claim 9, wherein if a third command is input to the data terminal and then a fourth address is input to the data terminal for a duration of M cycles of the clock signal, a fifth address which is an operation result of the base address and the fourth address is used as an effective address while the base address is not updated.

14. The serial memory device of claim 13, wherein the fifth address is calculated by adding the fourth address to the base address.

15. The serial memory device of claim 14, wherein the fourth address is represented by a two's complement.

16. A signal processing system, comprising:
the serial memory device of claim 1; and
a host controller which performs reception and transmission of command, address, and data via serial communication with the serial memory device.

17. A signal processing system, comprising:
the serial memory device of claim 9; and
a host controller which performs reception and transmission of command, address, and data via serial communication with the serial memory device.
